(19) United States
(12) Patent Application Publication
(10) Pub. No.: US 2007/0125408 A1
(43) Pub. Date: Jun. 7, 2007

(54) Clamping apparatus for washing optical members

(75) Inventor: Hsin-Ho Lee, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,326

(22) Filed: Jul. 26, 2006

(30) Foreign Application Priority Data
Dec. 2, 2005 (TW) 94142496

(51) Int. Cl. B08B 3/00

(52) U.S. Cl. 134/195; 134/199

(57) ABSTRACT

An exemplary clamping apparatus (9) for optical members includes a top fixture (10) and a bottom fixture (20). The top fixture has a top washing slot (13) defined therein. The bottom fixture has a bottom washing slot (24) defined therein. The bottom washing slot communicates with the top washing slot. The bottom fixture and the top fixture are mounted together for receiving the optical members.

### 1. FIELD OF THE INVENTION

The present invention generally relates to clamping apparatuses and, more particularly, to a clamping apparatus configured for washing optical members such as optical lenses, optical filters, or such like.

### 2. DESCRIPTION OF RELATED ART

With the ongoing development of microcircuitry and multimedia technologies, digital cameras have become a highly popular way of taking pictures. High-end portable electronic devices, such as mobile phones and personal digital assistants (PDAs), are being developed to include increasing numbers of special features. Many of these portable electronic devices are now equipped with a digital camera module, these electronic devices enable consumers to enjoy capturing digital pictures anytime and anywhere, the smallest and most eye-catching cameras being the most popular.

In camera modules, optical lenses are very important to the quality of the pictures captured by the camera modules. In the manufacturing process, the optical lenses need to be washed before plating a film thereon. Generally, optical elements are washed with ultrasonic waves in a vessel filled with liquid. The optical elements are prone to collide with each other under the influence of the ultrasonic waves. As a result, a surface of each optical element may easily be scraped or damaged. Therefore, optical elements need to be fixed in a clamping apparatus so that the optical elements are separated from each other and do not collide with each other.

A typical clamping apparatus is a holding board defining a plurality of receiving holes therein. Each receiving hole has a shape and size corresponding to the optical element. In use, each optical element is received in one of the receiving holes, and the holding board is then put in a liquid to be washed with ultrasonic waves. Because all the optical elements are received in the receiving holes, impurities on surfaces of the optical elements touching the holding board may not be removed.

Therefore, a new clamping apparatus is desired in order to overcome the above-described shortcomings.

### SUMMARY OF THE INVENTION

In one aspect thereof, a clamping apparatus for washing optical members includes a top fixture and a bottom fixture. The top fixture has a top washing slot defined therein. The bottom fixture has a bottom washing slot defined therein. The bottom washing slot communicates with the top washing slot. The bottom fixture and the top fixture are mounted together for receiving the optical members.

Other advantages and novel features of the embodiments will become more apparent from the following detailed description thereof when taken in conjunction with the accompanying drawings.

### BRIEF DESCRIPTION OF THE DRAWINGS

Many aspects of the present clamping apparatus can be better understood with reference to the following drawings. The components in the drawings are not necessarily drawn to scale, the emphasis instead being placed upon clearly illustrating the principles of the clamping apparatus and its potential applications. Moreover, in the drawings, like reference numerals designate corresponding parts throughout the several views.

FIG. 1 is an assembled, isometric view of a clamping apparatus in accordance with a preferred embodiment;

FIG. 2 is an enlarged, isometric view of a top fixture of the clamping apparatus shown in FIG. 1;

FIG. 3 is an enlarged, isometric view of a bottom fixture of the clamping apparatus shown in FIG. 1;

FIG. 4 is an isometric view of a holder of the clamping apparatus shown in FIG. 1; and

FIG. 5 is an assembled, isometric view of the top fixture and the bottom fixture of the clamping apparatus shown in FIG. 1.

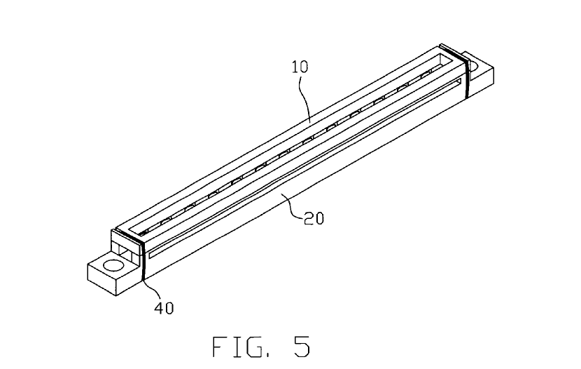

### DETAILED DESCRIPTION OF THE EMBODIMENTS

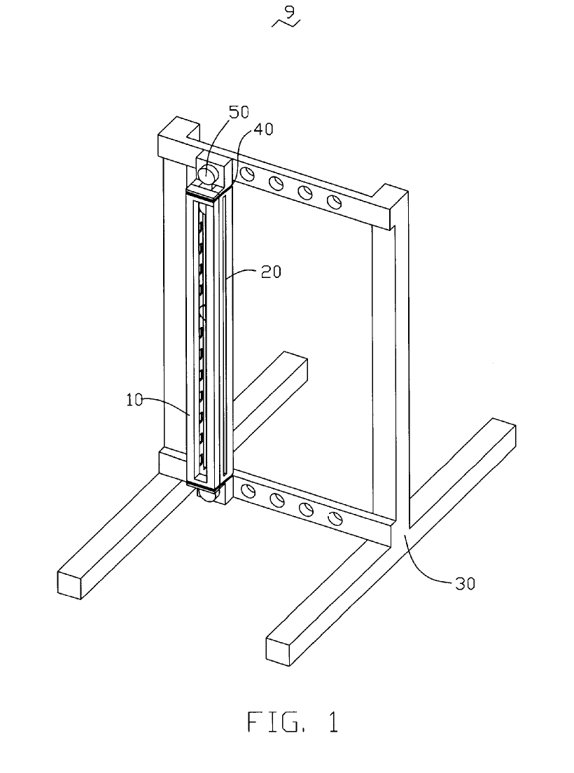

Referring now to the drawings in detail, FIG. 1 shows a clamping apparatus 9 of a preferred embodiment of the present invention. The clamping apparatus 9 is capable of washing a plurality of optical members at once. The optical members may be optical lenses, optical filters, or such like. The clamping apparatus 9 includes a top fixture 10, a bottom fixture 20, a holder 30, two securing members 40, and two bolts 50. The top fixture 10 and the bottom fixture 20 are fixed together with the securing members 40. The fixed top fixture 10 and bottom fixture 20 are mounted to the holder 30 with the two bolts 50.

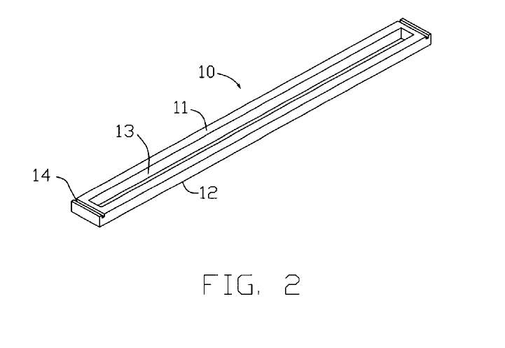

Also referring to FIG. 2, the top fixture 10 is a rectangular board in shape and has a top surface 11 and a bottom surface 12. The top surface 11 is opposite to the bottom surface 12. The top fixture 10 defines a top washing slot 13 therethrough. The top washing slot 13 is rectangular in shape and extends from one end of the top fixture 10 to the other opposite end of the top fixture 10. A top groove 14 is defined in the top surface 111 at each of two opposite ends of the top fixture 10.

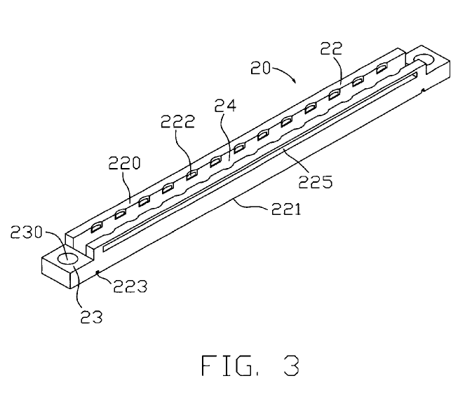

Also referring to FIG. 3, the bottom fixture 20 includes two positioning sidewalls 22 and two positioning blocks 23. Two ends of each positioning sidewall 22 connect with the two positioning blocks 23 respectively, thereby forming a bottom washing slot 24. A height of each positioning sidewall 22 is larger than that of each positioning block 23.

Each positioning sidewall 22 is a rectangular board in shape and has a top surface 220 and a bottom surface 221. The top surface 220 is positioned opposite to the bottom surface 221. Each positioning sidewall 22 defines a plurality of receiving cavities 222 in the top surface 220. The receiving cavities 222 all communicate with the bottom washing slot 24. Each receiving cavity 222 is arcuate in shape, corresponding to a rim of the optical member. Each receiving cavity 222 of one positioning sidewall 22 cooperates with one corresponding receiving cavity 222 of another positioning sidewall 22 to receive one optical member. A bottom groove 223 is defined in the bottom surface 221 at each of two opposite ends of each positioning sidewall 22. The bottom grooves 223 of the bottom fixture 20 are for engaging with the top grooves 14 of the top fixture 10. Each positioning sidewall 22 defines a side washing slot 225 therethrough along a horizontal direction. The side washing slot 225 communicates with the bottom washing slot 24.

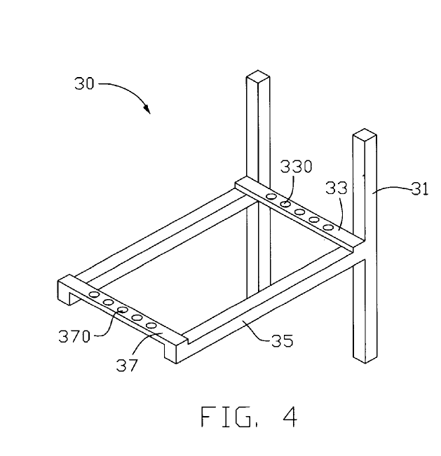

Also referring to FIG. 4, the holder 30 includes two base poles 31, two supporting arms 35, a bottom connecting pole 33, and a top connecting pole 37. The base poles 31, the supporting arms 35, the bottom connecting pole 33, and the top connecting pole 37 are all rectangular in shape. The two base poles 31 are parallel to each other. Each supporting arm 35 is perpendicularly formed at a central portion of each base pole 31, thus the supporting arms 35 are parallel to each other. The bottom connecting pole 33 connects bottom ends of the supporting arms 35. The top connecting pole 37 connects top ends of the supporting arms 35. The bottom connecting pole 33 is parallel to the top connecting pole 37. The bottom connecting pole 33 defines a plurality of mounting holes 330 therein. The top connecting pole 37 defines a plurality of mounting holes 370 therein. The mounting holes 330, 370 are screw holes.

Each of the securing members 40 is a cord or an elastic band. The securing member 40 may be made of metal, plastic, or rubber. The securing members 40 are configured for being secured in the top grooves 14 and the bottom grooves 223 for fixing the top fixture 10 to the bottom fixture 20. The bolts 50 are configured for being secured in the mounting holes 330, 370 for fixing the top fixture 10 and the bottom fixture 20 to the holder 30.

In use, a plurality of optical members are disposed in the receiving cavities 222 of the bottom fixture 20. The top fixture 10 is disposed on the top surface 220 of the bottom fixture 20 with the bottom surface 12 of the top fixture 10 on the top surface 220. The top fixture 10 is fixed to the bottom fixture 20 with two securing members 30 being secured in the top grooves 14 and the bottom grooves 223. The assembled top fixture 10 and bottom fixture 20 are fixed to the bottom connecting pole 33 and the top connecting pole 37 with the bolts 50 being secured in the mounting holes 330, 370. As such, a plurality of optical members may be mounted in the clamping apparatus 9 ready for washing. After washing, the washed optical members can be taken out from the carrying assembly 20.

It is to be understood that the receiving cavity 222 is not limited to being arcuate in shape. The receiving cavity 222 may alternatively have a different configuration corresponding to a shape of the optical member.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A clamping apparatus for washing optical members, comprising:
a top fixture having a top washing slot defined therein; and
a bottom fixture having a bottom washing slot defined therein, the bottom washing slot communicating with the top washing slot, and the bottom fixture and the top fixture being mounted together for receiving the optical members.

2. The clamping apparatus as claimed in claim 1, wherein the bottom fixture defines a plurality of receiving cavities, and the receiving cavities communicate with the bottom washing slot.

3. The clamping apparatus as claimed in claim 1, wherein the bottom fixture includes two positioning sidewalls and two positioning blocks, the positioning sidewalls and the positioning blocks cooperate with each other to define the bottom washing slot.

4. The clamping apparatus as claimed in claim 3, wherein the positioning sidewall defines a side washing slot, and the side washing slot communicates with the bottom washing slot.

5. The clamping apparatus as claimed in claim 1, further comprising a securing member, wherein the top fixture defines a top groove in a top surface thereof, the bottom fixture defines a bottom groove in a bottom surface thereof, and the top fixture is mounted on a top surface of the bottom fixture by the securing member secured in the top groove and the bottom groove.

6. The clamping apparatus as claimed in claim 5, wherein the securing member is one of a cord and an elastic band.

7. The clamping apparatus as claimed in claim 1, further comprising a holder, wherein the top fixture and the bottom are mounted to the holder.

8. The clamping apparatus as claimed in claim 7, wherein the holder defines a mounting hole therein, the bottom fixture defines a mounting hole therein, and the bottom fixture is mounted to the holder by a bolt engaged in the mounting holes.

9. An apparatus for clamping a plurality of optical members to be washed, the apparatus comprising:
a first fixture defining a first washing slot therein;
a second fixture coupled to the first fixture in a manner so as to allow their separation, the second fixture defining a second washing slot therein in communication with the first washing slot; and
a plurality of spaced receiving cavities formed between the first and second fixtures in communication with the first and second washing slots, the receiving cavity being configured for engagingly receiving the optical members as the first and second fixture being coupled together.

10. The apparatus of claim 9, further comprising a holder to which the combination of the first and second fixture is attached.

11. The apparatus of claim 10, wherein the holder includes a first connecting pole and a second connecting pole, the combination of the first and second fixtures has first and second mounting ends mounted to respective first and second connecting poles.

12. The apparatus of claim 11, wherein each of the first and second mounting pole defines a plurality of spaced mounting portions for mounting a plurality of such first and second fixtures.

13. The apparatus of claim 9, wherein at least one of the first and second fixtures defines a third washing slot communicating the first and second washing slots.

14. The apparatus of claim 9, wherein the first fixture includes two spaced positioning walls cooperatively defining the first washing slot therebetween, and the positioning walls define the receiving cavities in surfaces thereof facing toward the second fixture.
